(19) United States
(12) Patent Application Publication
(10) Pub. No.: US 2026/0155078 A1
(43) Pub. Date: Jun. 4, 2026

(54) DISPLAY DEVICE

(71) Applicant: Shanghai AVIC Optoelectronics Co., Ltd., Shanghai (CN)

(72) Inventors: Jiro YANASE, Kawasaki (JP); Masamichi SHIMODA, Kawasaki (JP); Genshiro KAWACHI, Kawasaki (JP); Hiroshi HAGA, Kawasaki (JP); Hiroaki KIMURA, Kawasaki (JP); YingTeng ZHAI, Xiamen (CN); YuanJian CUI, Shanghai (CN)

(73) Assignee: Shanghai AVIC Optoelectronics Co., Ltd., Shanghai (CN)

(21) Appl. No.: 19/404,093

(22) Filed: Dec. 1, 2025

(30) Foreign Application Priority Data
Dec. 2, 2024 (JP) 2024-209798

(51) Int. Cl. G09G 3/20; G09G 3/32

(52) U.S. Cl. CPC G09G 3/2007; G09G 3/32; G09G 2310/08; G09G 2320/0233; G09G 2320/0242

(57) ABSTRACT

A pixel circuit includes a control transistor for driving current for a pixel and a pulse width modulation circuit to supply a control signal to the control transistor. The pulse width modulation circuit switches ON/OFF the control transistor with the control signal to control an emission period of the pixel in one frame period. The pulse width modulation circuit switches ON/OFF a driving transistor that outputs the control signal, using a gray-level data voltage from a control circuit, a first ramp signal, and a second ramp signal steeper than the first ramp signal. The second ramp signal is used in control for a low gray-level range including the minimum gray level and not used in control for a high gray-level range including gray levels higher than the low gray-level range. The first ramp signal is used in at least the control for the high gray-level range.

### CROSS-REFERENCE TO RELATED APPLICATIONS

This non-provisional application claims priority under 35 U.S.C. § 119(a) on Patent Application No. 2024-209798 filed in Japan on Dec. 2, 2024, the entire content of which is hereby incorporated by reference.

### BACKGROUND

This disclosure relates to a display device.

Display devices utilizing micro-light-emitting diodes (micro-LEDs) employ pulse width modulation (PWM) driving that modulates the emission periods to display halftones. Among a plurality of PMW driving methods, analog PWM driving has been standardized in recent years. The analog PWM driving varies the emission pulse width in an analogue manner in accordance with the gray level data.

The pixel circuit to be driven by the analog PWM includes a constant current generation (CCG) unit, a PWM unit, and a switch. The CCG unit generates constant current. The PWM unit compares a gray-level data voltage representing gray-level data with a ramp signal and converts the gray level data voltage to a pulse signal. The switch turns ON/OFF the current generated by the CCG unit in accordance with the pulse signal from the PWM unit.

The analog PWM driving requires rectangular pulses for the ideal driving current; however, the current by the actual circuit does not fall instantly and its finite falling time (transition time) causes degradation in display quality in the low gray-level range. The length of the falling time is one of the issues and especially, it is a major issue to achieve good grayscale expression in the low-level range.

### SUMMARY

A display device includes a plurality of pixel circuits and a control circuit configured to control the plurality of pixel circuits. Each of the plurality of pixel circuit includes a control transistor for driving current for a pixel and a pulse width modulation circuit to supply a control signal to the control transistor. The pulse width modulation circuit includes a driving transistor to output the control signal. The pulse width modulation circuit is configured to switch ON/OFF the control transistor with the control signal to control an emission period of the pixel in one frame period. The pulse width modulation circuit is configured to switch ON/OFF the driving transistor using a gray-level data voltage from the control circuit, a first ramp signal, and a second ramp signal steeper than the first ramp signal. The second ramp signal is used in control for a low gray-level range including the minimum gray level and not used in control for a high gray-level range including gray levels higher than the low gray-level range. The first ramp signal is used in at least the control for the high gray-level range.

It is to be understood that both the foregoing general description and the following detailed description are exemplary and explanatory and are not restrictive of this disclosure.

### BRIEF DESCRIPTION OF THE DRAWINGS

FIG. 1 schematically illustrates the configuration of a pixel circuit related to an embodiment of this disclosure.

FIG. 2 illustrates temporal variation of input signal voltages VRAMP and VDATA to a PWM circuit, control signal voltage VOUT output from the PWM circuit, and driving current ILED to a micro-LED.

FIG. 3A illustrates the state of a pixel circuit at the time T1 in FIG. 2.

FIG. 3B illustrates the state of a pixel circuit at the time T2 in FIG. 2.

FIG. 3C illustrates the state of a pixel circuit at the time T3 in FIG. 2.

FIG. 3D illustrates the state of a pixel circuit at the time T4 in FIG. 2.

FIG. 3E illustrates the state of a pixel circuit at the time T5 in FIG. 2.

FIG. 4 illustrates an example of a PWM circuit configured of thin-film transistors and capacitors.

FIG. 5 schematically illustrates waveforms of a ramp signal VRAMP, the gate voltage Vg of the driving thin-film transistor in a PWM circuit, control signal voltage VOUT from the PWM circuit, and driving current ILED for a micro-LED.

FIG. 6 provides a simulation result on the input-output characteristic (static characteristic) of the PWM circuit.

FIG. 7 provides a verification result by a simulation on the relation between the gradient of the ramp signal VRAMP and the falling time of the LED driving current ILED.

FIG. 8 schematically illustrates the waveforms of the ramp signal VRAMP and the LED driving currents ILED in response to different gray-level data voltages.

FIG. 9 is a timing chart of control signals for the pixel circuits in an embodiment of this disclosure.

FIG. 10 provides simulation results on the LED driving current for different gray levels.

FIG. 11 provides a simulation result on the relation between the gray level and the peak value of the LED driving current.

FIG. 12 provides a simulation result on the relation between the deviation of the average current caused by a threshold voltage variation of the driving thin-film transistor in a PWM circuit and the gradient of the ramp signal VRAMP.

FIG. 13 provides simulation results on the relation between the gradient of the ramp signal and the deviation of the average current.

FIG. 14 is a conceptual diagram of the waveform of two ramp signals in one frame period.

FIG. 15 is a plan diagram illustrating a configuration example of a micro-LED display device.

FIG. 16 illustrates a configuration example of a gray-level data voltage generation unit in a signal circuit.

FIG. 17 provides an example of a gamma LUT to be used in the configuration using a single ramp signal per frame.

FIG. 18A provides a configuration example of the gamma LUT in Embodiment 1 for the first subperiod where a gentle ramp signal is used.

FIG. 18B provides a configuration example of the gamma LUT in Embodiment 1 for the second subperiod where a steep ramp signal is used.

FIG. 19A provides a configuration example of a gamma LUT in Embodiment 2 for the first subperiod where a gentle ramp signal is used.

FIG. 19B provides a configuration example of a gamma LUT in Embodiment 2 for the second subperiod where a steep ramp signal is used.

FIG. 20 provides simulation results on the LED driving current for different gray levels in Embodiment 2.

FIG. 21 provides a simulation result on the average current in Embodiment 1 when the gray levels are varied only in the central region of the display region and kept the same in the other region.

FIG. 22 provides another simulation result on the average current in Embodiment 1 when the gray levels are varied only in the central region of the display region and kept the same in the other region.

FIG. 23 provides a simulation result on the average current in Embodiment 2 when the gray levels are varied only in the central region of the display region and kept the same in the other region.

FIG. 24 is a timing chart of pixel control signals in progressive driving in Embodiment 3.

FIG. 25 provides temporal variation of the ramp signal in one frame period in Embodiment 4 and simulation results on the temporal variation of the LED driving current for different gray levels.

FIG. 26 is a timing chart of pixel control signals in Embodiment 4.

FIG. 27 illustrates a configuration example in Embodiment 5 where each pixel is divided into two subpixels.

FIG. 28 is a timing chart of pixel control signals in Embodiment 5.

### EMBODIMENTS

An aspect of this disclosure describes control of light emission of a micro-light-emitting diode (micro-LED). The pixel circuit for controlling light emission of a microLED lights the micro-LED for an emission period having a length in accordance with gray-level data and then stops lighting the micro-LED in one frame period. A longer emission period means higher brightness.

An embodiment of this disclosure controls the emission period (brightness) of a micro-LED by pulse width modulation (PWM) in accordance with gray-level data. The method of driving a micro-LED by PWM control (PWM driving) supplies pulse driving current (also referred to as lighting current or LED current) having a pulse width in accordance with gray-level data to the micro-LED to light the micro-LED.

The pulse width is a length between the medians in the rise and the fall of a pulse driving current; a longer pulse width means a longer emission period or higher brightness. The driving current for a low gray-level range does not reach the highest value for a high gray-level range; its waveform may consist of a steep rising edge and a gentle falling edge.

The analog PWM driving requires a rectangular waveform for the ideal driving current. However, the current by the actual circuit does not fall steeply; a finite falling time (transition region) exists where the driving current value decreases little by little. During the falling time, the driving current gradually decreases.

The emission wavelength of a micro-LED shifts to a shorter wavelength with increase in density of the driving current and then, shifts toward a longer wavelength with further increase. The external quantum efficiency (EQE) of a micro-LED significantly degrades when the driving current density is low. Especially in the case where the supply period of the driving current for a low gray-level only consists of a falling time, the adverse effect onto the emission of the micro-LED is high. Accordingly, the length of this falling time is a major issue in the PWM driving of a micro-LED.

A pixel circuit in an aspect of this disclosure includes a constant current circuit, a PWM circuit, and a current control switch. The constant current circuit generates a constant current. The PWM circuit generates a control signal based on a gray-level data volage and ramp signals having different gradients. The current control switch turns ON/OFF the current flowing from the constant current circuit to the micro-LED depending on the control signal from the PWM circuit.

### Embodiment 1

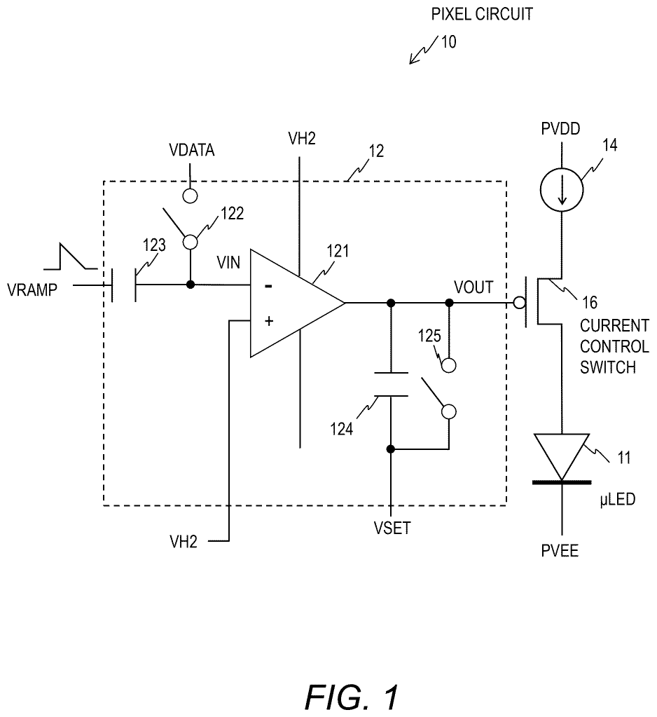

FIG. 1 schematically illustrates the configuration of a pixel circuit related to an embodiment of this disclosure. The display region of the display device includes micro-LEDs (μLEDs) 11arrayed in a predetermined layout, for example, in a matrix. The display device includes pixel circuits 10 for individually controlling the micro-LEDs 11. Each pixel circuit 10 includes a constant current circuit 14, a PWM circuit 12, and a current control switch 16. The current control switch 16 is a control transistor for the driving current for a micro-LED 11. All micro-LEDs 11 may be for the same color of light or the display region can include micro-LEDs for different colors of light, for example, red light, blue light, and green light. In this example, one micro-LED 11 corresponds to a single light-emitting region and it is associated with a pixel circuit. The features of this disclosure can be applied to light-emitting elements different from the micro-LED.

A micro-LED 11 includes an anode and a cathode. The cathode of the microLED 11 is supplied with a constant power-supply voltage PVEE. The constant current circuit 14 and the PWM circuit 12 can have any internal configurations; the PWM circuit 12 in FIG. 1 is an example.

The constant current circuit 14 generates a constant current. A current control switch 16 is provided between the constant current circuit 14 and the micro-LED 11. The current control switch 16 is a thin-film transistor (also simply referred to as transistor) and this switch 16 in the configuration example of FIG. 1 is a p-type thin-film transistor. The active layer of the p-type thin-film transistor can be made of low-temperature polysilicon, for example. Instead of the current control switch 16, a driving thin-film transistor included in the constant current circuit 14 may be controlled by the PWM circuit 12. This driving thin-film transistor is a control transistor for the LED driving current. In this case, the driving thin-film transistor in the constant current circuit 14 controls the magnitude of the LED driving current with its gate voltage and it is turned ON/OFF depending on the output voltage of the PWM circuit 12.

In the configuration example of FIG. 1, the source of the current control switch 16 is connected to a terminal of the constant current circuit 14 and the drain is connected to the anode of the micro-LED 11. The current control switch 16 is disposed on the path of the current that flows from the constant current circuit 14 to the power line for supplying a power-supply voltage PVEE via the micro-LED 11 to turn ON/OFF the path.

The current control switch 16 can be disposed between the micro-LED 11 and the power line for supplying the power-supply voltage PVEE. The current control switch 16 can be an n-type thin-film transistor. The active layer of the n-type thin-film transistor can be made of oxide semiconductor or low-temperature polysilicon, for example.

The constant current circuit 14 is supplied with a power-supply voltage PVDD to generate and output a constant current. The power-supply voltage PVDD is higher than the power-supply voltage PVEE. The output of the current from the constant current circuit 14 is turned ON/OFF by the current control switch 16.

The PWM circuit 12 includes a comparator 121, a switch 122, capacitors 123 and 124, and another switch 125. One end of the switch 122 and one end of the capacitor 123 are connected to the inverting input of the comparator 121. The non-inverting input of the comparator 121 is supplied with a constant voltage VH2. The comparator 121 is further supplied with the constant voltage VH2 as a power-supply voltage.

The comparator 121 compares the input signal voltage VIN to the inverting input terminal with the reference voltage VH2 to the non-inverting input terminal and outputs an output signal voltage VOUT indicating the comparison result. The output signal voltage VOUT of the comparator 121 is supplied to the gate of the current control switch 16 as a control signal voltage for controlling ON/OFF of the current control switch 16.

The switch 122 switches ON/OFF the path between the transmission line for the gray-level data voltage VDATA and the inverting input of the comparator 121. The other end of the capacitor 123 is supplied with a ramp signal VRAMP. The ramp signal VRAMP is a voltage (signal) that linearly increases or decreases with time and the gray-level data voltage VDATA is a voltage in accordance with the gray level of a pixel of a video frame. The examples of the ramp signal described in the following are mainly ramp signals whose voltages decrease but ramp signals whose voltages increase can also be used.

The capacitor 124 is configured between the gate of the current control switch 16 and the line for supplying a constant voltage VSET. The constant voltage VSET is lower than the constant voltage VH2. An end of the capacitor 124 is connected to a node between the gate of the current control switch 16 and the output of the comparator 121 and the other end is connected to the line for supplying the constant voltage VSET.

The switch 125 switches ON/OFF the path between the gate of the current control switch 16 and the line for supplying the constant voltage VSET. One end of the switch 125 is connected to a node between the gate of the current control switch 16 and the output of the comparator 121 and the other end is connected to the line for supplying the constant voltage VSET.

The PWM circuit 12 generates a control signal voltage VOUT from the gray-level data voltage VDATA and outputs it. The signal voltage input to the PWM circuit 12 includes the gray-level data voltage VDATA and the variation ΔVRAMP of the ramp signal. The PWM circuit 12 compares the gray-level data voltage VDATA representing the gray-level data with the variation ΔVRAMP of the ramp signal and outputs the control signal voltage VOUT of a pulse signal.

The PWM circuit 12 in FIG. 1 compares the summed voltage of the gray-level data voltage VDATA and the variation ΔVRAMP of the ramp signal with the constant voltage VH2 using the comparator 121 and outputs a control signal voltage VOUT in accordance with the magnitude relation therebetween. This operation corresponds to the comparison of the gray-level data voltage VDATA with the variation ΔVRAMP of the ramp signal VRAMP. The PWM circuit 12 turns off the switch 16 by outputting a high (H) level voltage VH2 from the comparator 121 to stop the supply of the current to the micro-LED 11.

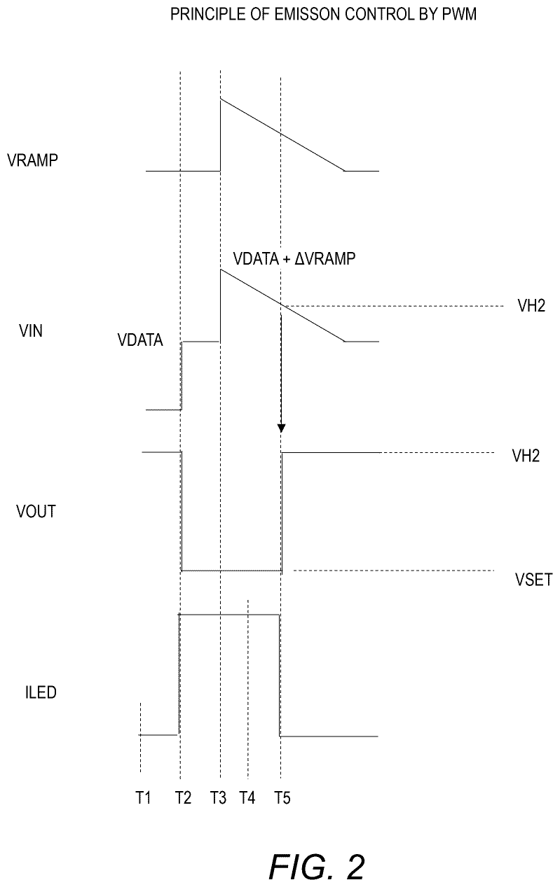

FIG. 2 illustrates temporal variation of the input signal voltages VRAMP and VDATA to the PWM circuit 12, the control signal voltage VOUT output from the PWM circuit 12, and the driving current ILED to the micro-LED 11. The input signal voltage VIN to the inverting input terminal of the comparator 121 is the summed voltage of the gray-level data voltage VDATA and the variation ΔVRAMP of the ramp signal VRAMP.

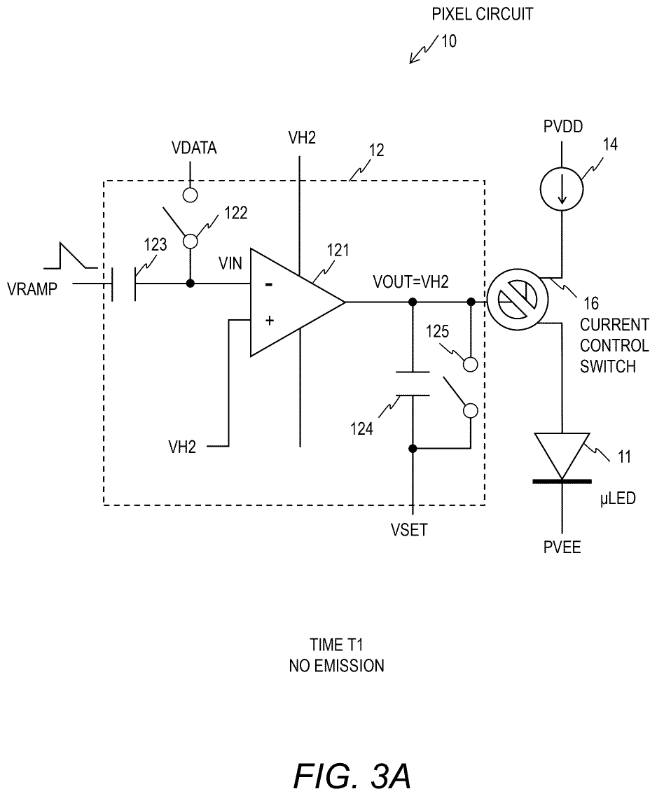

FIGS. 3A to 3E illustrate the states of a pixel circuit 10 at the times T1 to T5 in FIG. 2. Hereinafter, circuit operation of the pixel circuit 10 is described with reference to FIGS. 2 and 3A to 3E.

With reference to FIG. 3A illustrating the state at the time T1, the micro-LED 11 does not emit light. The time T1 is included in a non-emission period. The switches 122 and 125 are OFF. With reference to FIG. 2, the input voltage to the comparator 121 at the time T1 is the minimum voltage to be the reference. The control signal voltage VOUT from the PWM circuit 12 is the H-level of VH2 output from the comparator 121. Accordingly, the current control switch 16 is OFF; the driving current ILED to the microLED 11 is cut off.

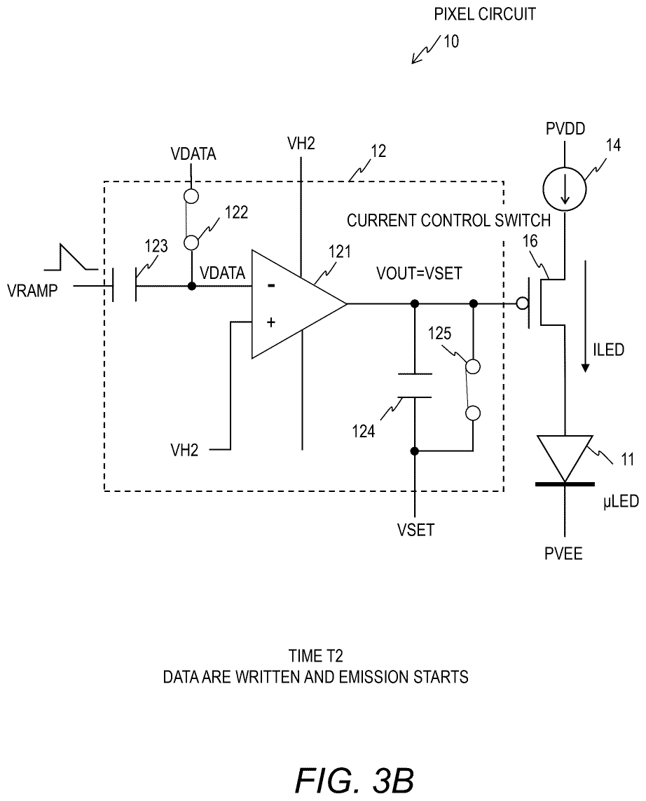

With reference to FIG. 3B illustrating the state at the time T2, the switches 122 and 125 are turned ON. With reference to FIG. 2, the gray-level data voltage VDATA corresponding to the gray level in the video frame data is written to the PWM circuit 12 at the time T2. The period from the time T2 to the time T3 is a period to write the gray-level data voltage. Since the switch 125 is ON, the control signal voltage VOUT from the PWM circuit 12 is the L-level of VSET. Accordingly, the current control switch 16 is ON; the driving current ILED is supplied to the micro-LED 11 and the micro-LED 11 starts emitting light. In the example of FIG. 3B, the switches 122 and 125 are ON together during the period from the time T2 to the time T3. In another example, the time to turn ON can be different between these switches as indicated by the signals S1 and S2 in FIG. 4.

With reference to FIG. 3C illustrating the state at the time T3, the switches 122 and 125 are turned OFF. With reference to FIG. 2, the ramp signal VRAMP starts to be input at the time T3. The summed voltage of the gray-level data voltage VDATA and the variation ΔVRAMP of the ramp signal is higher than the voltage VH2. The control signal voltage VOUT from the PWM circuit 12 is maintained at VSET of the L-level. The current control switch 16 keeps ON and the micro-LED 11 keeps emitting light.

With reference to FIG. 3D illustrating the state at the time T4, the switches 122 and 125 remain OFF. With reference to FIG. 2, the summed voltage of the gray-level data voltage VDATA and the variation ΔVRAMP of the ramp signal is higher than the voltage VH2. The control signal voltage VOUT from the PWM circuit 12 is maintained at VSET of the L-level. The current control switch 16 keeps ON and the micro-LED 11 keeps emitting light.

With reference to FIG. 3E illustrating the state at the time T5, the switches 122 and 125 remain OFF. With reference to FIG. 2, the summed voltage of the gray-level data voltage VDATA and the variation ΔVRAMP of the ramp signal has decreased to the voltage VH2. The control signal voltage VOUT from the PWM circuit 12 changes from VSET of the L-level to VH2 of the H-level. In response to the change of the control signal voltage VOUT, the current control switch 16 is turned OFF and the micro-LED 11 stops emitting light.

As described above, the pulse width of the driving current for the micro-LED 11 depends on the gray-level data voltage VDATA. In other words, the emission period of the micro-LED 11 is controlled by the gray-level data voltage VDATA.

FIG. 4 illustrates an example of a PWM circuit 12 configured of thin-film transistors and capacitors. The switches 122 and 125 and the comparator 121 are p-type thin-film transistors. The gate of the switch 125 is supplied with a selection signal (scanning signal) S1 and the gate of the switch 122 is supplied with a selection signal (scanning signal) S2. The switches 122 and 125 are controlled by the selection signals S1 and S2 in the same manner as described with reference to FIGS. 3A to 3E.

The pixel circuit in FIG. 4 includes another p-type switching thin-film transistor 131 between the constant current circuit 14 and the source of the current control switch 16. The thin-film transistor 131 is controlled by a control signal EM. The thin-film transistor 131 can be disposed at a different location on the path of the LED driving current and its conductive type can be either one.

The gate of the thin-film transistor 121 corresponds to the inverting input of a comparator and it is supplied with the input signal voltage VIN. The source of the thin-film transistor 121 is supplied with the constant voltage VH2. The drain of the thin-film transistor 121 is connected to the gate of the current control switch 16. The thin-film transistor 121 outputs a control signal voltage VOUT for controlling ON/OFF of the current control switch 16. Accordingly, the thin-film transistor 121 can be referred to as driving thin-film transistor in the PWM circuit 12.

Although all thin-film transistors included in the pixel circuit 10 in FIG. 4 are p-type thin-film transistors, one or more, even all of the thin-film transistors can be n-type thin-film transistors. The pixel circuit 10 can further include elements such as a thin-film transistor and a capacitor in addition to the elements shown in FIG. 4 and/or exclude some elements from the elements shown in FIG. 4. The same applies to the control signals for the pixel circuit 10; one or more kinds of control signals can be added and/or one or more of the signals can be excluded.

In FIG. 2, the driving current ILED for the micro-LED 11 falls steeply at the time T5. This waveform is an ideal one and actually, the driving current ILED falls very gently. Unlike the falling edge, the rising edge of the driving current ILED has an almost ideal steep gradient. This is because the switching thin-film transistor 131 is provided on the path of the LED driving current and the voltage at its gate changes steeply from high to low in the order of sub-microseconds, like the emission control signal EM.

The driving current ILED slowly and gradually decreases from the maximum value to zero with time. The driving current ILED in the constant current PWM driving is not cut off instantly, providing a period where the driving current ILED is not constant. The ideal constant current PWM driving is not accomplished.

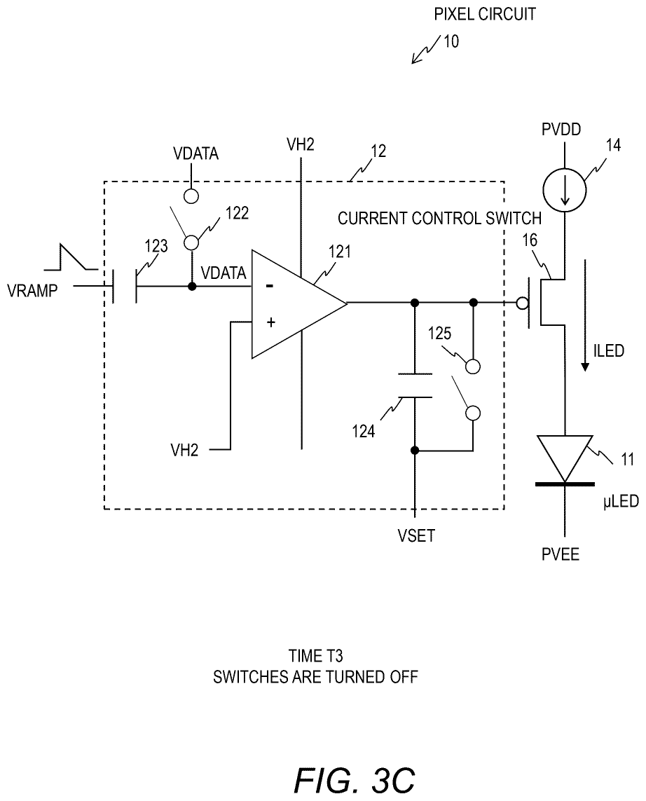

FIG. 5 schematically illustrates waveforms of the ramp signal VRAMP, the gate voltage Vg of the driving thin-film transistor 121 in the PWM circuit 12, the control signal voltage VOUT from the PWM circuit 12, and the driving current ILED for the micro-LED 11.

As the ramp signal VRAMP gradually falls, the gate voltage Vg of the driving thin-film transistor 121 in the PWM circuit 12 falls. When the gate voltage Vg reaches the threshold voltage Vth, the driving thin-film transistor 121 turns from OFF to ON. The output voltage VOUT from the PWM circuit 12, however, gradually increases from VSET to VH2. This rising time is the response time of the output voltage VOUT from the PWM circuit 12. As the output voltage VOUT from the PWM circuit 12 gradually increases, the driving current ILED for the micro-LED 11 decreases gradually.

As for the pulse width modulation for a micro-LED 11, a long falling time of the driving current ILED may cause considerable variations in emission efficiency and chromaticity among micro-LEDs and degrade the display quality. This is because the LED driving current has low density in the falling time. As described above, the falling time of the driving current ILED is caused by the response time (rising time) of the control signal voltage VOUT output from the PWM circuit 12.

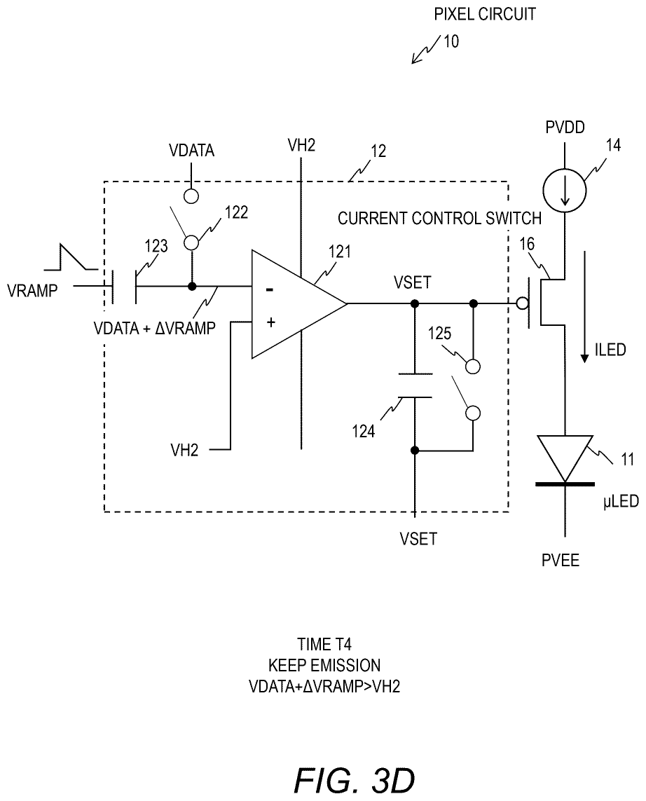

FIG. 6 provides a simulation result on the input-output characteristic (static characteristic) of the PWM circuit 12. The broken line represents the ideal characteristic and the solid line represents the characteristic of the actual circuit. The input-output characteristic reflects the steepness of the Id-Vg characteristic of the driving thin-film transistor 121. This simulation result indicates that the gate voltage of the driving thin-film transistor 121 needs to vary by 0.61 V to supply sufficient drain current Id after the transistor 121 turns ON.

The time required for the gate voltage to vary by this 0.61 V is the response time of the control signal voltage VOUT output from the PWM circuit 12. The time required for the gate voltage to vary by 0.61V with gradual fall of the potential of the ramp signal VRAMP corresponds to the falling time of the LED driving current. In the case of grayscale display using a single ramp signal, the gradient of the ramp signal becomes smaller depending on the pulse width of the output VOUT of the PWM circuit 12 in outputting the peak brightness or the maximum gray level. To increase the emission duty for the maximum gray level as high as possible, a longer pulse width is appreciated; the potential of the ramp signal falls gently with a long time for about just under one frame. For this reason, the input voltage of 0.61 V required for the control signal voltage VOUT to respond is an unignorable amount for the emission control of a micro-LED 11.

The inventors found, through their research on the constant current PWM driving of micro-LEDs, that the response time of the PWM circuit 12 or the falling time of the LED driving current ILED is correlated to the gradient of the ramp signal and the sharpness of the Id-Vg characteristic of the thin-film transistor. Specifically, they found that increasing the gradient of the ramp signal reduces the response time of the output voltage VOUT of the PWM circuit 12 and as a result, it reduces the falling time of the driving current ILED, too. Furthermore, they found that a more appropriate range exists for the gradient of the ramp signal, which will be described later.

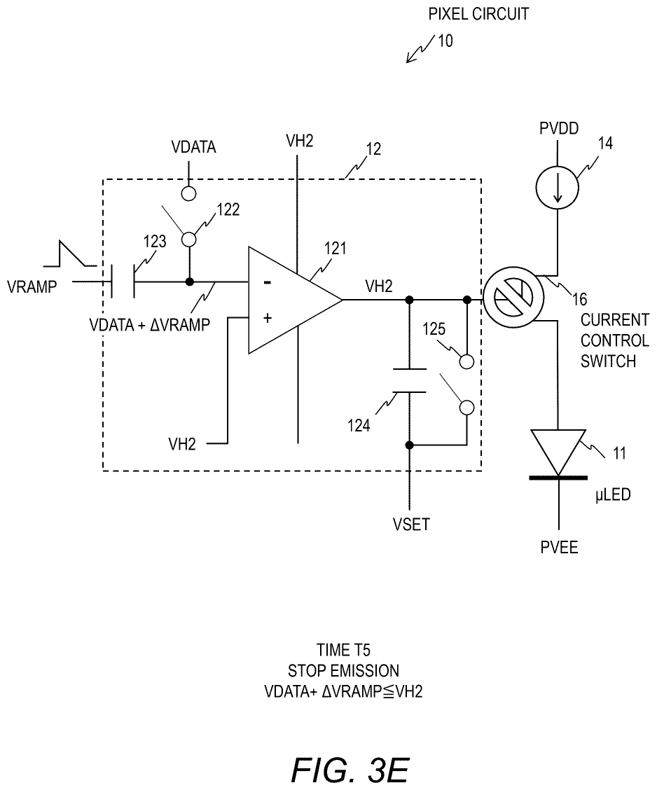

FIG. 7 provides a verification result by a simulation on the relation between the gradient of the ramp signal VRAMP and the falling time of the LED driving current ILED. The horizontal axis of the graph represents the gradient of the ramp signal VRAMP and the vertical axis represents the falling time of the LED driving current ILED. As understood from the graph of FIG. 7, when the gradient of the ramp signal VRAMP is larger, the falling time of the output current from the current control switch 16 is shorter.

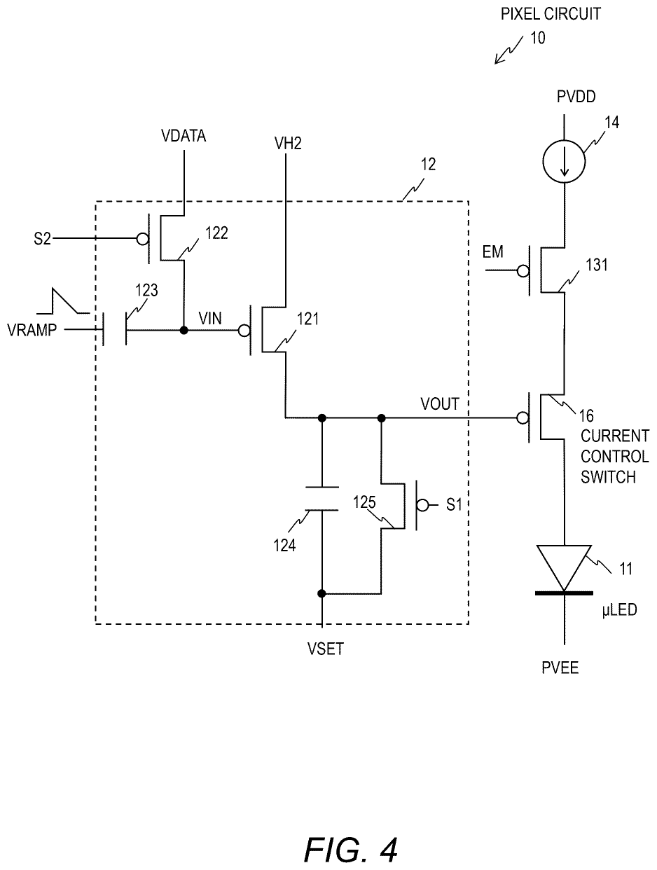

The importance of the falling time of the LED driving current ILED is higher in the low gray-level range for which the emission period is short. FIG. 8 schematically illustrates the waveforms of the ramp signal VRAMP and the LED driving currents ILED in response to different gray-level data voltages.

The waveform 201 is the waveform of the driving current for a high gray level; the waveform 202 is the waveform of the driving current for an intermediate gray level; and the waveform 203 is the waveform of the driving current for a low gray level. For example, the maximum gray level is 255 and the minimum gray level is 0.

The waveforms 201 and 202 for the high gray level and the intermediate gray level have pulse widths longer than their falling times and their peak values (highest current values) are the same. The waveforms 201 and 202 have a period showing a constant (maximum) current value. In the waveforms 201 and 202, the driving current rises to reach the maximum value, maintains the maximum value, and then falls. The pulse width here is defined as the time width between the medians (the half value of the maximum value) in the rising edge and the falling edge of the waveform (half-value width). The rising edge can be regarded as substantially vertical.

The waveform 203 of the driving current for a low gray level has a pulse width shorter than the falling time and the peak value (highest current value) is lower than those of the other waveforms 201 and 202. The waveform 203 starts falling immediately from the highest value and does not have a period showing a constant value. When the pulse width of the driving current is shorter than the falling time like this case, the peak value of the driving current becomes lower. That is to say, the density of the current flowing through the LED is low, causing variations in brightness and chromaticity among LEDs. A long falling time of the LED driving current has more considerable effects on the emission for the low gray-level range.

An embodiment of this disclosure applies different ramp signals (slopes) to the high gray-level range and the low gray-level range in generating LED driving current. More specifically, a gentler ramp signal (slope) is applied to the high gray-level range and a steeper ramp signal (slope) is applied to the low gray-level range. This configuration reduces the falling time in the low gray-level range where the effect of a long falling time is large and moreover, attains high brightness in the high gray-level range. As for the high gray-level range, the upper limit of the average current or the emission duty is raised by increasing the width of the ramp signal to provide a gentler ramp signal. The gradient of the ramp signal can be altered with the voltage amplitude of the ramp signal. However, the voltage amplitude is finite and increasing the voltage amplitude increases the power consumption. Reducing the falling time in the low gray-level range reduces the variations in brightness and chromaticity based on the characteristics of the micro-LEDs (improves the uniformity in brightness and chromaticity) and further, reduces the variations in average current caused by the variations of thin-film transistors (improves the uniformity in average current).

Hereinafter, an example of applying two kinds of ramp signals different in gradient to different gray-level ranges is described. Three or more ramp signals having different gradients may be applied to different gray-level ranges. The steeper ramp signal is applied to the lower gray-level range. The gradient of a ramp signal can be rising (positive) or falling (negative) depending on the circuit design. A steeper gradient means that the absolute value of the gradient is greater.

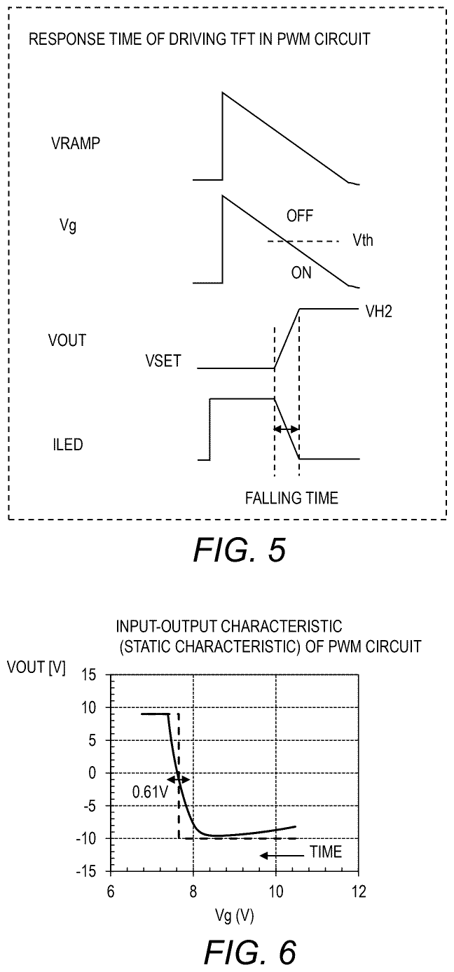

FIG. 9 is a timing chart of control signals for the pixel circuits 10 in an embodiment of this disclosure. The control signals are supplied from a driver circuit not shown in FIG. 9. FIG. 9 illustrates temporal variation in one frame period of the gray-level data voltage VDATA, the scanning signal (selection signal) SCAN[k], the emission control signal EM, and the ramp signal VRAMP. The scanning signal SCAN[k] is a scanning signal for selecting the k-th pixel row out of N pixel rows, where N and k are natural numbers. The scanning signal SCAN is supplied to the pixel rows one after another with a delay of one horizontal period. The emission control signal EM is a control signal for the switching thin-film transistors 131 on the path of the LED driving current. Here is a supplemental description about the relation between S1 and S2 shown in FIG. 4. The signal S2 is delayed from the signal S1 by one horizontal period and they have a relation of SCAN[k−1]=S1, SCAN[k]=S2. The scanning signals for the (k−1)th row and the k-th row are used for the pixel circuits in the k-th row. Using the signal for an adjacent row contributes to a smaller radix of (number of units in) the scanning circuit.

The pixel circuits 10 of this disclosure separate one frame period in video data into two subperiods. In one subperiod, the pixel circuits 10 for the high gray-level range light their micro-LEDs 11 and the pixel circuits 10 for the low gray-level range keep their micro-LEDs 11 from lighting. In the other subperiod, the pixel circuits 10 for the low gray-level range light their micro-LEDs 11 and the pixel circuits 10 for the high gray-level range keep their micro-LEDs 11 from lighting.

In the first subperiod of the configuration example in FIG. 9, the pixel circuits 10 for the high gray-level range write gray-level data voltages corresponding to the gray levels specified in the video frame and light their micro-LEDs 11. The pixel circuits 10 for the low gray-level range write the gray-level data voltage for non-emission (at the zero current level) and keep their micro-LEDs 11 from lighting.

In the second subperiod following the first subperiod, the pixel circuits 10 for the high gray-level range write the gray-level data voltage for non-emission (at the zero current level) and keep their micro-LEDs 11 from lighting. The pixel circuits 10 for the low gray-level range write gray-level data voltages corresponding to the gray levels specified in the video frame and light their micro-LEDs 11. In this way, each pixel circuit 10 is selected by the scanning signal SCAN[k] in both of the first subperiod and the second subperiod and gray-level data voltages are written thereto.

The pixel circuits 10 are supplied with a gentle ramp signal VRAMP in the first subperiod for the high gray-level range and supplied with a steep ramp signal VRAMP in the second subperiod for the low gray-level range. For example, the pixel circuits 10 substantially use the steep ramp signal VRAMP for the low gray-level range under the gray level 65 and use the gentle ramp signal VRAMP for the high gray-level range over the gray level 64. In another example, emission for the low gray-level range can be made in the first subperiod and the emission for the high gray-level range can be made in the second subperiod.

In the first subperiod, the driver circuit of the display device writes gray-level data voltages VDATA to all pixel circuits 10 and then lights the micro-LEDs 11 for the high gray-level range. Subsequently, all pixel circuits 10 stop lighting the micro-LEDs 11. In the second subperiod, the driver circuit writes gray-level data voltages VDATA to all pixel circuits 10 and then lights the micro-LEDs 11 for the low gray-level range. Subsequently, all pixel circuits 10 stop lighting the micro-LEDs 11.

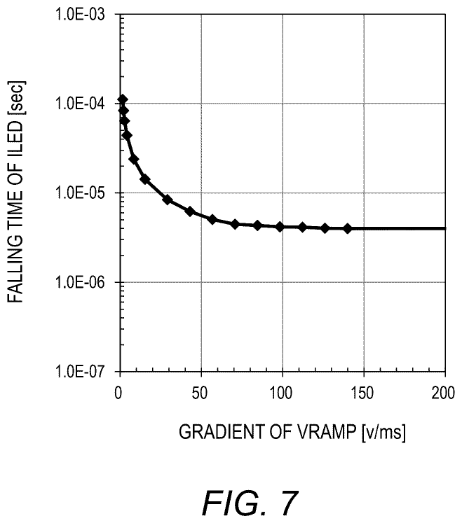

FIG. 10 provides simulation results on the LED driving current for different gray levels. The graph 221 provides the waveform of the ramp signal VRAMP in one frame period. The graphs 222, 223, 224, and 225 provide the waveforms of the LED driving current for the gray levels 255, 127, 65, and 64, respectively, in one frame period. The pixel circuit 10 uses the gentle ramp signal 227 for the high gray-level range over the level 64 and uses the steep ramp signal 228 for the low gray-level range under the level 65. The maximum gray level is 255 and the minimum gray level is 0, for example. As indicated in the graphs 222 to 225, the pulse width of the LED driving current decreases as the gray level is lowered.

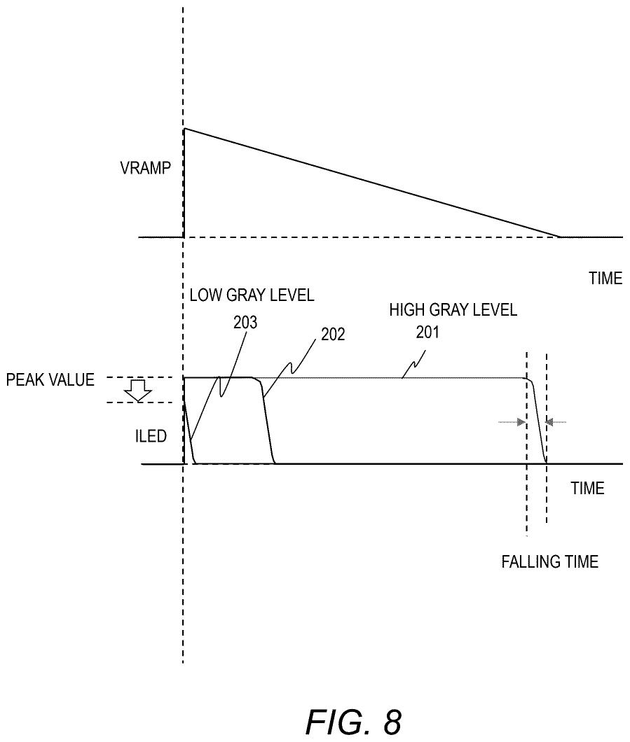

FIG. 11 provides a simulation result on the relation between the gray level and the peak value of the LED driving current. The horizontal axis of the graph of FIG. 11 represents the gray level and the vertical axis represents the peak value of the LED driving current. The broken line represents the LED driving current in the case of a waveform of a single ramp signal and the solid line represents the LED driving current in the case of a waveform of two ramp signals having different gradients.

As described with reference to FIG. 8, the peak value of the LED driving current is the same (uniform) in the high gray-level range but in the low gray-level range, it decreases as the gray level is lowered. With reference to the graph of FIG. 11, the both lines decrease as the gray level is lowered in the low gray-level range. However, the LED driving current in the case of the waveform of two ramp signals having different gradients is higher than the LED driving current in the case of the waveform of a single ramp signal at any gray level.

In the case of a single ramp signal (voltage waveform thereof), the lower limit of the gray level to be able to keep the maximum LED driving current in the entire gray-level range is the level 26. In contrast, in the case of two ramp signals, the lower limit of the gray level to be able to keep the maximum LED driving current in the entire gray-level range is the level 15. That is to say, the emission control by two ramp signals can keep the maximum value of the LED driving current down to a lower gray level.

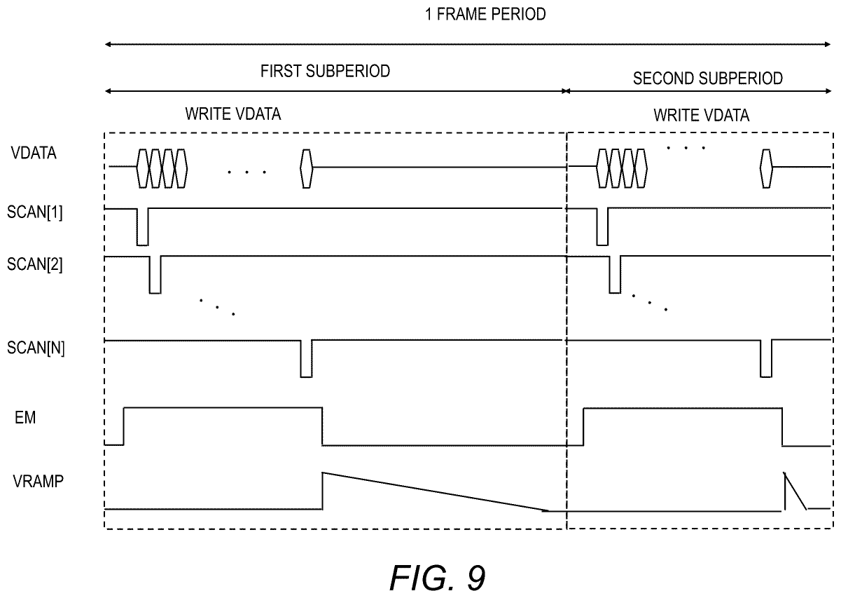

FIG. 12 provides a simulation result on the relation between the deviation of the average current caused by a threshold voltage shift of the driving thin-film transistor 121 in the PWM circuit 12 and the gradient of the ramp signal VRAMP. The average current here is obtained by integrating the current in an interval of an integral multiple of one frame and dividing the integrated value by the interval. The average current and the brightness are strongly correlated. In the graph of FIG. 12, the horizontal axis represents the gradient (absolute value thereof) of the ramp signal and the vertical axis represents the deviation of the average current caused by a threshold voltage shift of the thin-film transistor 121, assuming that the threshold voltage shift is −0.5 V and the driving thin-film transistor 121 in the PWM circuit 12 performs threshold voltage compensation.

With reference to the graph of FIG. 12, the gradient of the single ramp signal can be 0.9 V/ms (assuming that the frame rate is 120 Hz and the width of the ramp signal corresponds to the length of one frame period) and the steeper gradient in the two ramp signals can be 29.1 V/ms. As understood from the graph of FIG. 12, increasing the gradient of the ramp signal significantly reduces the deviation of the average current caused by the threshold voltage shift of the thin-film transistor 121. For example, the deviation of the average current is reduced to 1/13 when the gradient is increased from 0.9 V/ms to 29.1 V/ms.

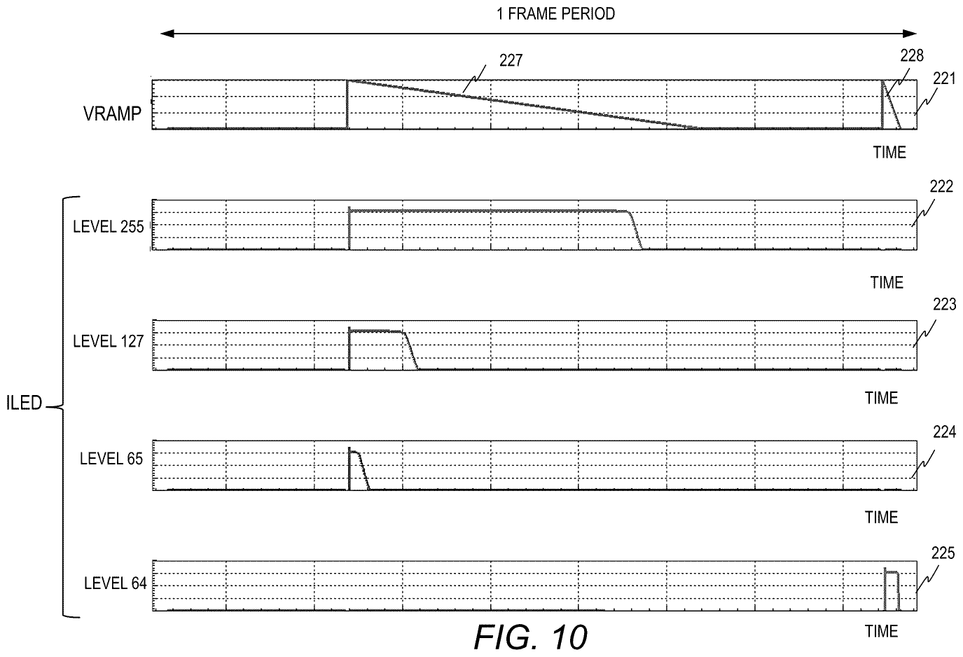

FIG. 13 provides simulation results on the relation between the gradient (the absolute value thereof) of the ramp signal and the deviation of the average current. The horizontal axis represents the gradient (the absolute value thereof) of the ramp signal and the vertical axis represents the deviation of the average current when the threshold voltage of the driving thin-film transistor 121 in the PWM circuit 12 is shifted by −0.5 V. The line 251 represents the relation in a pixel circuit that does not perform threshold voltage compensation and the line 252 represents the relation in a pixel circuit that performs threshold voltage compensation. Independently from whether to perform threshold voltage compensation, the deviation of the average current decreases as the gradient of the ramp signal increases.

To simplify this principle, the case without threshold voltage compensation is described. The driving thin-film transistor 121 in the PWM circuit 12 is OFF at the start of light emission and turns ON when the gate-source voltage Vgs has exceeded the threshold voltage Vth. In response, the LED driving current starts falling.

Accordingly, when the threshold voltage Vth becomes higher (in the case of a p-type semiconductor, shifts negatively), the pulse width of the LED driving current becomes longer. This indicates the pulse width of the current and the threshold voltage are strongly correlated. However, when the gate voltage Vgs changes very quickly, the difference in pulse width of the current caused by the difference in threshold voltage Vth becomes smaller. That is to say, as the gradient of the ramp signal increases, the gate voltage of the driving thin-film transistor 121 changes more quickly and as a result, the effect of the difference in threshold voltage diminishes. Although threshold voltage compensation decreases the deviation, the tendency that a steeper ramp signal decreases the deviation is the same. Even if the threshold voltage compensation is performed, the deviation before the compensation is carried over to some extent. Accordingly, the effect of the Vth shift can be reduced by increasing the gradient of the ramp signal although threshold voltage compensation is usually performed on the driving thin-film transistor.

As described above, the configuration using ramp signals having different gradients improves various characteristics of the pixel circuit for controlling the light emission of a micro-LED 11. The inventors' research revealed that there is a more appropriate range for the gradient of the ramp signal. Especially, the steepest ramp signal has the more appropriate range for its gradient. However, this disclosure does not eliminate the condition that the steepest gradient in the plurality of ramp signals (the waveform thereof) is out of the range described in the following.

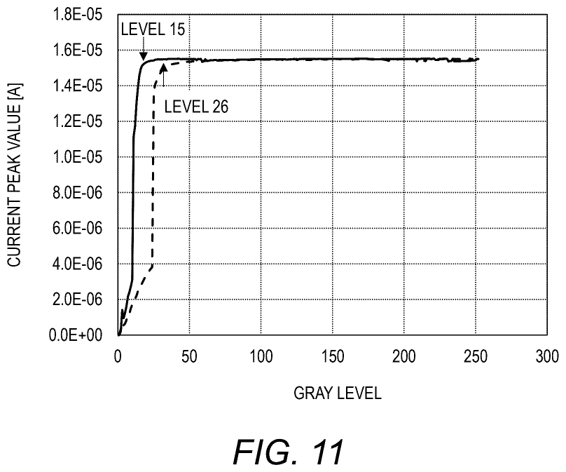

First, the lower limit for the gradient (the absolute value thereof) of the ramp signal is described. FIG. 14 is a conceptual diagram of the waveform of two ramp signals 261 and 262 in one frame period. As premises for this example, the second ramp signal 262 has a steeper gradient than the first ramp signal 261 and the ramp signals 261 and 262 have the same amplitude (the absolute value of the difference between the start voltage and the end voltage).

Let b be the amplitude and a be the gradient of the second ramp signal 262. The gradient a in the example of FIG. 14 is negative. In addition, let f be the frame frequency. One frame period is 1/f. For the second ramp signal 262 to have a steeper gradient than the first ramp signal 261 in one frame period, the following condition should be satisfied:
a<−2bf.

Accordingly, the maximum value for the gradient a or its absolute value |a| should satisfy the following condition:
   |a|>2bf.
   The lower limit for the absolute value |a| of the gradient of the ramp signal 262 is 2bf. When the voltage amplitude b of the ramp signal is 6 V and the frame rate f is 120 Hz, 2bf defining the lower limit is 1.44 V/ms.

In the case of using three or more ramp signals, the absolute value of the gradient of the steepest ramp signal should satisfy the following condition:
   |a|>nbf,
   where n is an integer greater than 2. The following description is about a configuration using two ramp signals having different gradients.

As illustrated in FIG. 7, the falling time tf of the LED driving current decreases as the absolute value |a| of the gradient of the ramp signal increases from 0. However, the falling time tf reaches a saturation value when the absolute value |a| of the gradient takes a specific value and becomes substantially uniform in the range where the absolute value |a| of the gradient is greater than the specific value. This is because the potential of the ramp signal has fallen to the limit (the potential is saturated) and the Vgs and Id of the driving thin-film transistor 121 in the PWM circuit 12 are also saturated. Accordingly, even if the gradient of the ramp signal is increased more than the specific value, the falling time tf does not change.

In the range where the falling time tf decreases to the saturation value, the falling time tf can be logically expressed by the following formula:

tf=−0.2 s/a (Formula 1)

where s represents the S-value of the driving thin-film transistor 121 in the PWM circuit 12.

Next, the upper limit for the absolute value |a| of the gradient of the ramp signal 262 is described. As described above, the falling time tf reaches the saturation value when the absolute value |a| of the gradient takes a specific value and becomes substantially uniform in the range where the absolute value |a| of the gradient is greater than the specific value. This is because the amplitude of the ramp signal is finite and fixed. The amplitude of the ramp signal is equal to the data voltage range and usually, it is approximately 6 V. Expanding the data voltage range increases the power consumption to rewrite the voltages of the data lines. With reference to FIG. 7 providing a simulation result on the falling time of the LED current and the absolute value |a| of the gradient of the ramp signal 262, the upper limit for the absolute value |a| at which the falling time tf starts being saturated is 100. The saturation value of the falling time can be logically expressed by the following formula:

tf=8.7×C/β(VDATA−VH2)² (Formula 2)

where β represents the gain factor of the driving thin-film transistor 121 in the PWM circuit 12, C represents the capacitance of the capacitor 124 connected to the output node of the driving thin-film transistor 121, VH2 represents the positive power-supply voltage to the driving thin-film transistor 121 in the PWM circuit 12, and VDATA represents the gray-level data voltage.

From the above Formulae 1 and 2 about the falling time tf, the gradient a with which the falling time tf reaches the saturation value is expressed by the following formula:

a=(−0.023s×β)×(VDATA−VH2)²/C.

Since the width of the ramp signal becomes shorter with increase in the gradient of the ramp signal, the upper limit of the current pulse width becomes shorter to prevent the width of the ramp signal from unnecessarily becoming short. In other words, assigning a value greater than the specific value to |a| does not reduce the falling time of the LED current but it lowers the upper limit of the emission duty.

In view of the foregoing description, the appropriate range for the absolute value |a| of the gradient of the ramp signal 262 can be expressed as follows:

2×b×f<|a|<(0.023s×β)×(VDATA−VH2)²/C.

Some numerical examples are provided as follows: the ramp signal amplitude b=6V, the frame frequency f=120 Hz, the capacitance C=307 fF, the voltage VH2=9 V, the gray-level data voltage VDATA=6.5 V, the gain factor β=5.9×10\hat{ }(−7). In the above expression defining the range for the absolute value |a| of the gradient, an example of the value defining the lower limit for the absolute value |a| of the gradient is 1.44 V/ms and an example of the value defining the upper limit for the absolute value |a| of the gradient is 100 V/ms.

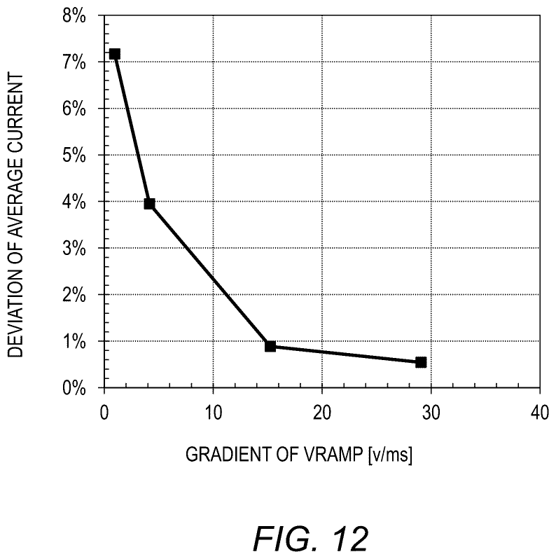

Generation of a gray-level data voltage is described. FIG. 15 is a plan diagram illustrating a configuration example of a micro-LED display device. The micro-LED display device includes a display region composed of an array of pixel circuits 10 and micro-LEDs 11, a signal circuit 31, and a scanning circuit 32.

Each of the signal circuit 31 and the scanning circuit 32 or the combination of these circuits are a driver circuit (also referred to as control circuit) for driving and controlling the pixel circuits 10. The signal circuit 31 and the scanning circuit 32 supply control signals and power-supply voltages for controlling the pixel circuits 10. FIG. 15 indicates the kinds of the output signals (including the control signals and the power-supply voltages) from the signal circuit 31 and the scanning circuit 32 for pixel circuits 10 illustrated in FIG. 4, which are taken by way of example. The kinds of the output signals from the driver circuit depend on the configuration of the pixel circuit.

A pixel circuit 10 controls a micro-LED 11. The components of the pixel circuit 10 is fabricated on a thin-film transistor (TFT) substrate. The micro-LED 11 is connected to connection pads 111 and 112 on the TFT substrate to be electrically connected to the pixel circuit 10 through the connection pads 111 and 112.

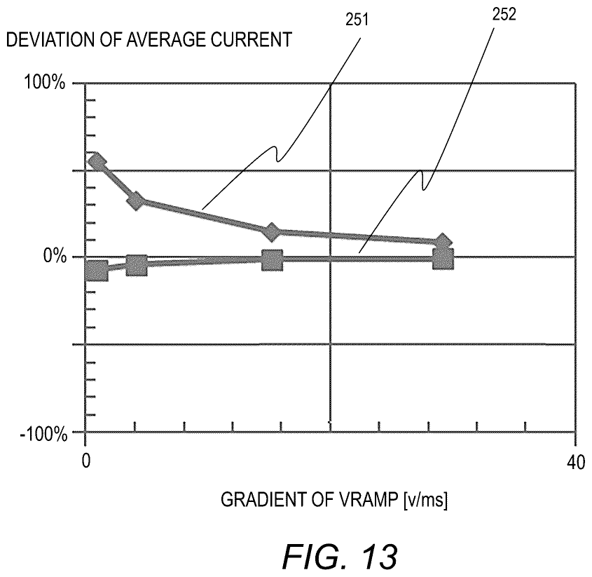

FIG. 16 illustrates a configuration example of a gray-level data voltage generation unit 310 in the signal circuit 31. The gray-level data voltage generation unit 310 includes a digital-analog converter (DAC) 311, a gamma voltage generator 313, and a memory 315. The memory 315 stores gamma lookup tables (LUTs) 317A and 317B. The gamma LUTs 317A and 317B are tables for two ramp signals having different gradients.

The gray-level data voltage generation unit 310 receives RGB image data extracted from video data and converts the digital signal to an analog signal with the DAC 311. The analog signal is written to a storage capacitor in each pixel circuit 10 as a gray-level data voltage. The storage capacitor in FIG. 16 corresponds to the capacitor 123 in FIG. 4. The DAC 311 generates gray-level data voltages from gray levels with reference to a plurality of gamma voltages. The gamma voltages define relations between gray levels and gray-level data voltages.

The gamma voltage generator 313 retrieves the gamma LUT 317A or 317B stored in the memory 315 and uses it. The gamma voltage generator 313 generates gamma voltages for individual gray levels from the digital data specified in the gamma LUT and outputs the gamma voltages with DACs. For example, the gamma voltage generator 313 uses the gamma LUT 317A for the gentle ramp signal and uses the gamma LUT 317B for the steep ramp signal. The gamma voltage generator 313 switches the gamma LUTs before writing gray-level data voltages in each of the first subperiod and the second subperiod in one frame period.

### Embodiment 2

Embodiment 2 has a technical feature in the relation between the gray level and the gray-level data voltage in the gamma LUTs. In a conventional configuration using a single ramp signal per frame, the pulse width of the LED driving current increases as the gray level increases. The number of gamma LUTs to be used is one.

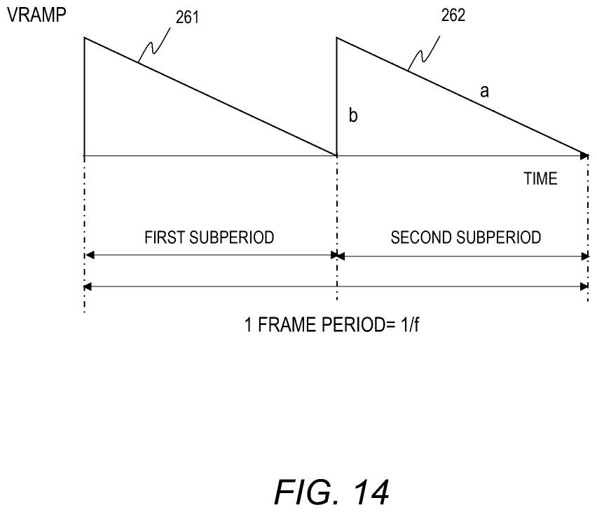

FIG. 17 provides an example of a gamma LUT to be used in the configuration using a single ramp signal per frame. In the graph in FIG. 17, the horizontal axis represents the gray level of a pixel acquired from video data and the vertical axis represents the gray-level data voltage. As the gray level increases, the gray-level data voltage increases. The condition that the gray-level data voltage does not decrease, or either increases or keeps a fixed value, in response to increase in gray level is desirable in designing the gray level data voltage generation unit 310. This is because the simplest example of the gray level data voltage generation unit 310 supplies a voltage across a resistor string configured by connecting a plurality of resistors in series and takes out voltages from intermediate nodes between resistors connected in series.

Embodiment 1 generates LED driving current with a steep ramp signal for the gray levels lower than the level 65 and generates LED driving current with a gentle ramp signal for the gray levels higher than the level 64, for example. Embodiment 1 uses the gentle ramp signal in the first subperiod and uses the steep ramp signal in the following second subperiod, for example.

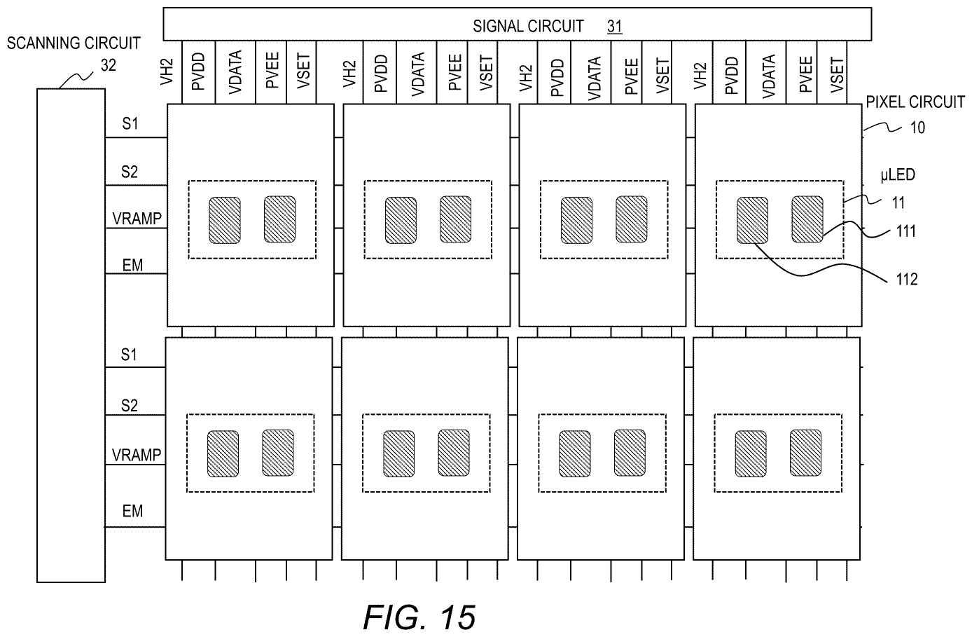

FIG. 18A provides a configuration example of the gamma LUT 317A in Embodiment 1 for the first subperiod where a gentle ramp signal is used. FIG. 18B provides a configuration example of the gamma LUT 317B in Embodiment 1 for the second subperiod where a steep ramp signal is used. In each graph, the horizontal axis represents the gray level and the vertical axis represents the gray-level data voltage.

With reference to FIG. 18A, the gray-level data voltage is fixed at a minimum value in the gray level range lower than the level 65 and increases monotonically with the following increase in gray level. This configuration satisfies the aforementioned desirable condition in designing the gray-level data voltage generation unit. However, there are pixel circuits for which the data voltage monotonically decreases with increase in gray level. The data voltage is desired to vary monotonically or to be fixed with increase in gray level.

With reference to FIG. 18B, the gray-level data voltage increases monotonically with increase in gray level in the gray level range lower than the level 65, falls to the minimum value at the level 65, and keeps the minimum value with the following increase in gray level. In short, the gray level voltage increases and then changes to decrease with increase in gray level. This configuration does not satisfy the aforementioned desirable condition in designing the gray-level data voltage generation unit.

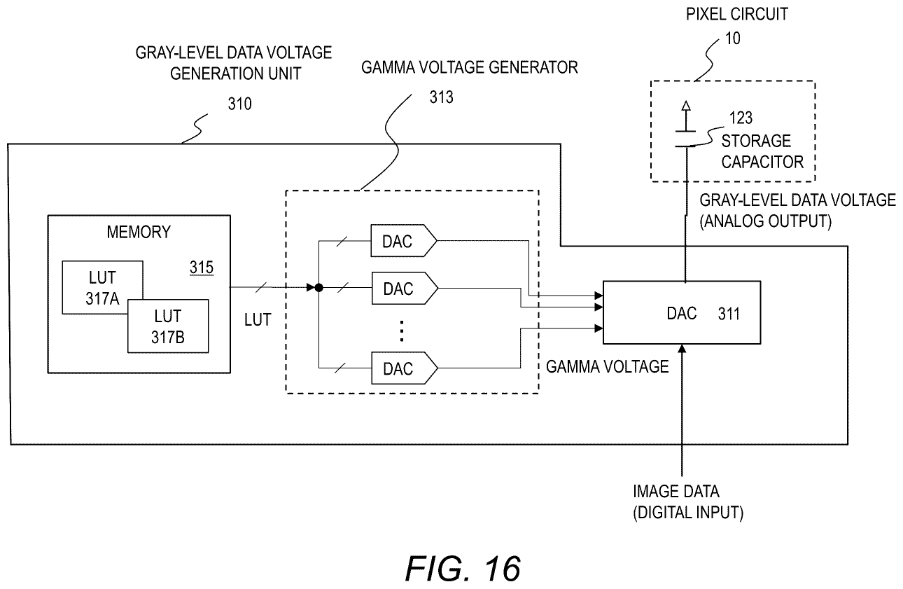

This embodiment creates gamma LUTs satisfying the foregoing condition. FIG. 19A provides a configuration example of a gamma LUT 327A in Embodiment 2 for the first subperiod where a gentle ramp signal is used. The gamma LUT 327A is for high gray levels and referred to as first table. FIG. 19B provides a configuration example of a gamma LUT 327B in Embodiment 2 for the second subperiod where a steep ramp signal is used. The gamma LUT 327B is for low gray levels and referred to as second table. In each graph, the horizontal axis represents the gray level and the vertical axis represents the gray-level data voltage.

With reference to FIG. 19A, the gamma LUT 327A keeps the gray-level data voltage at the minimum value in the gray level range lower than the level 65 and increases it monotonically with the following increase in gray level. With reference to FIG. 19B, the gamma LUT 327B increases the gray-level data voltage monotonically with increase in gray level in the range from the level 0 to the level 64 and keeps it at the maximum value with the following increase in gray level. The gray-level data voltages for the level 64 and the level 65 are equal.

The gray-data voltage generation unit 310 in this embodiment increases the gray-level data voltage with increase in gray level in the low gray-level range (for example, the range lower than the level 65) in the second subperiod where a steep ramp signal is used, like in Embodiment 1. In the high gray-level range (for example, the range higher than the level 64), it keeps the gray-level data voltage at a fixed value. The gray-level data voltage can be increased with increase in gray level in at least a part of the high gray-level range.

That is to say, the gray-level data voltage generation unit 310 outputs LED driving current even for a gray level higher than the level 64 when using a steep ramp signal. To counterbalance with it, the gray-level data voltage generation unit 310 reduces the LED driving current for the high gray-level range when using a gentle ramp signal in the first subperiod, compared to Embodiment 1.

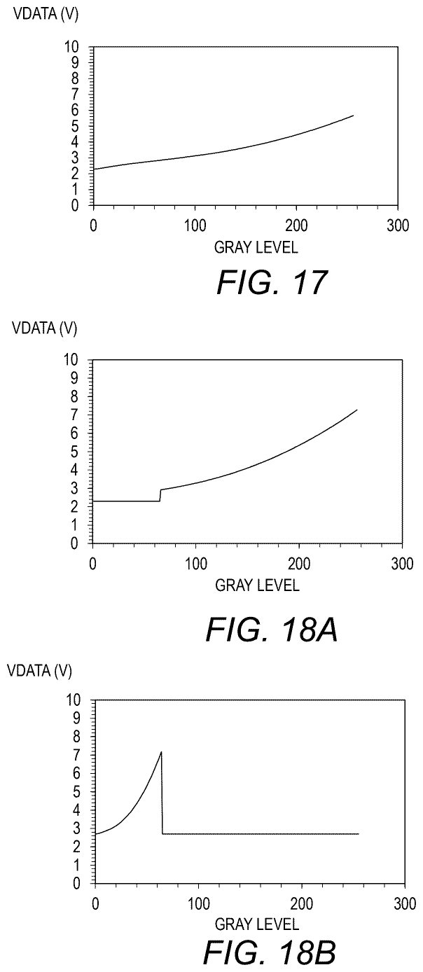

FIG. 20 provides simulation results on the LED driving current for different gray levels. The graph 281 provides the waveform of the ramp signal VRAMP in one frame period. The graphs 282, 283, 284, and 285 provide the waveforms of the LED driving current for the gray levels 255, 127, 65, and 64, respectively, in one frame period. The maximum gray level is 255 and the minimum gray level is 0.

The gray-level data voltage generation unit 310 uses a gentle ramp signal 287 and a steep ramp signal 288 for the high gray-level range over the level 64 and uses only the steep ramp signal 228 for the low gray-level range under the level 65. That is to say, current pulses are output in response to the ramp signals 287 and 288 for the high gray-level range. The brightness of a micro-LED 11 depends on the average value of the LED driving current (average current) in one or more frame periods. The average current is a value obtained by dividing the time-integrated value of the LED driving current by the time. Therefore, compared to Embodiment 1, the pulse width of the LED driving current for the high gray-level range in the first subperiod is short.

With reference to the graph 284 for the level 65, although the waveform shows a pulse having a low peak value in the first subperiod, the steep pulse in the second subperiod is dominant and therefore, the quality of the waveform of the averaged current is better than Embodiment 1. Furthermore, Embodiment 2 attains less motion picture false contours than Embodiment 1. The motion picture false contour is a kind of motion picture noise.

The display quality of motion pictures was evaluated as follows. A motion picture shifts the boundary between brightness and darkness and the human's line of sight follows it. The brightness at each point is time-integrated to be defined as brightness there. Since the renewal of the brightness is delayed by one frame, the brightness and the darkness on both sides of the boundary are mixed to become lateral gradation to get blurred for human eyes. In Embodiment 1, each micro-LED 11 is turned on in either the first subperiod or the second subperiod and turned off in the other subperiod. In the case of displaying a gradation of gray levels, the brightness of the border between the level 64 and the level 65 increases because the light emitted in the first subperiod and the light emitted in the second subperiod are added. In this embodiment, however, the micro-LEDs 11 for the levels higher than the level 64 are always lit in both periods; the continuity of the brightness in the border between gray levels improves and reduces the false contours.

This embodiment further suppresses the degradation in image quality caused by IR drop, which is a phenomenon that, when the LED driving current flows through the positive power line, its line resistance lowers the voltage. An example of the layout of the positive power lines includes a frame-like thick line outside the display region and thin linear lines along individual pixel columns. Accordingly, the drop of the positive power-supply voltage becomes maximum in the middle of the display region in the pixel column direction (the vertical direction).

In Embodiment 1, each micro-LED 11 is turned on in either the first subperiod or the second subperiod and turned off in the other subperiod, depending on the gray level. Accordingly, in the case where the entire display region displays an image at high gray levels, a large IR drop occurs in the first subperiod and no IR drop occurs in the second subperiod.

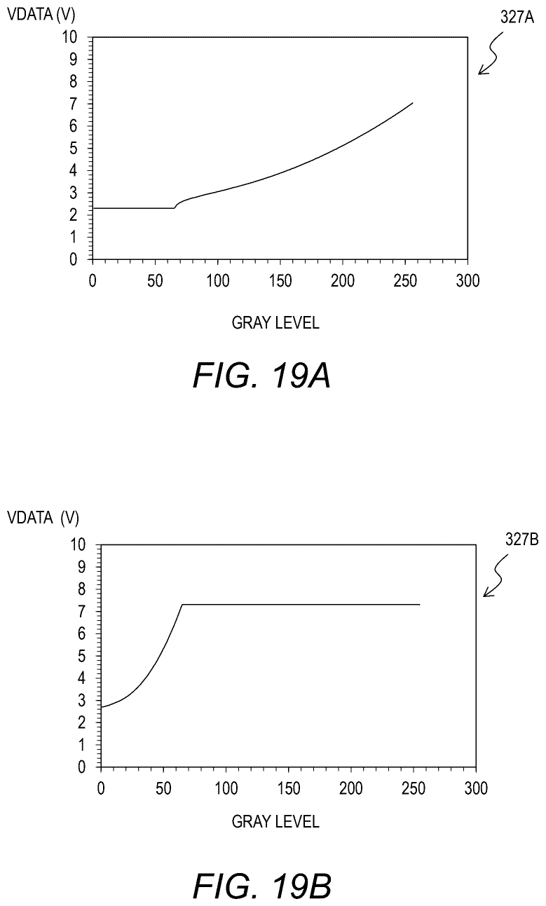

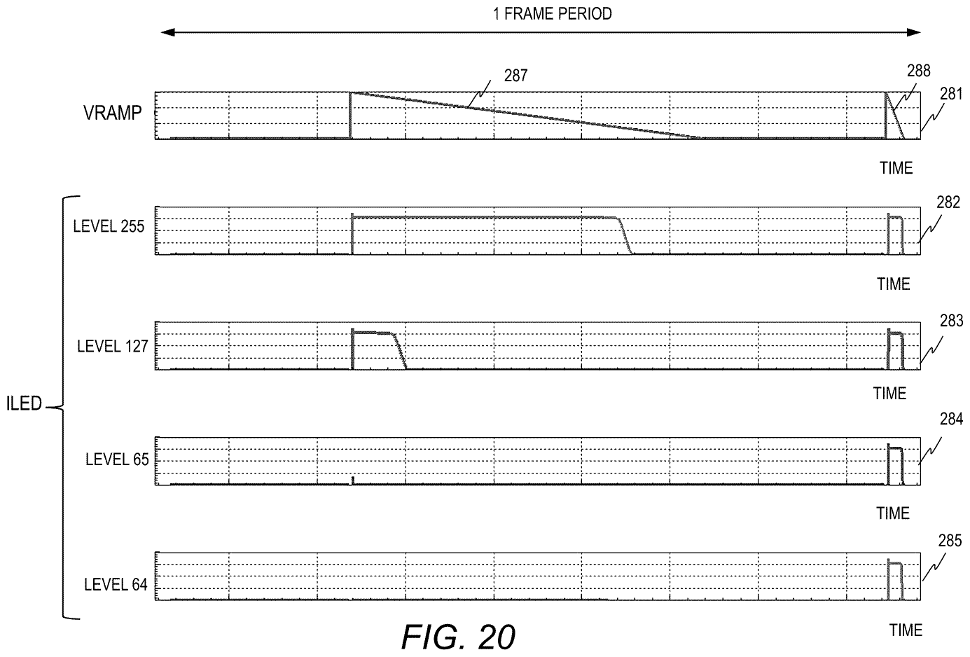

FIGS. 21 and 22 provide simulation results on the average current in Embodiment 1 when the gray levels are varied only in the central region of the display region and kept the same in the other region (circumjacent area of the central region). FIG. 21 provides a simulation result in the case where the gray levels in the other region were the maximum level of 255. FIG. 22 provides a simulation result in the case where the gray levels in the other region were the level 50 included in the low gray-level range. In each graph, the horizontal axis represents the gray level and the vertical axis represents the average current. In FIGS. 21 and 22, the balance of the IR drop is lost at the boundary between the gray levels to use different ramp signals, so that the relation of the brightness to the gray level becomes discontinuous.

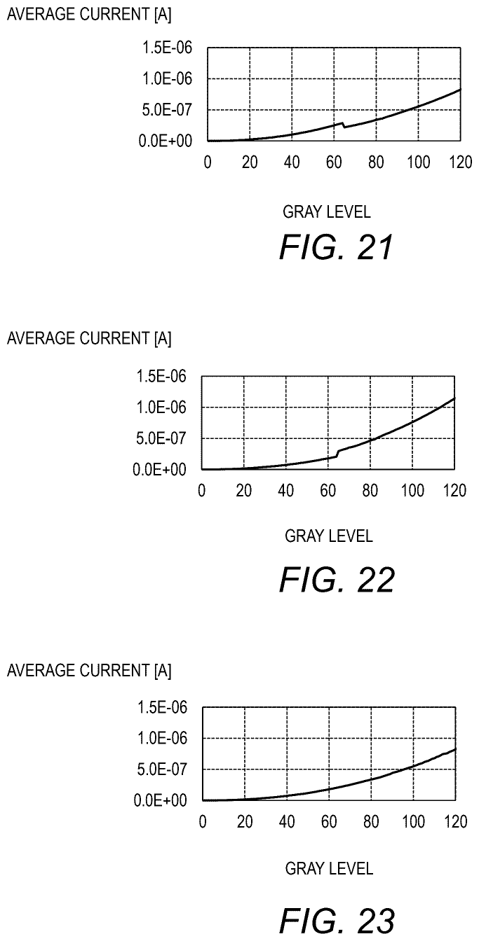

FIG. 23 provides a simulation result on the average current in Embodiment 2 when the gray levels are varied only in the central region of the display region and kept the same in the other region. In Embodiment 2, the micro-LEDs 11 for the high gray-level range are lit in the first subperiod and the second subperiod. Accordingly, IR drop occurs but its balance is kept; the continuity of the brightness with respect to the gray level is improved.

Creation of gamma LUTs in this embodiment is described. Creating a gamma LUT allots the overall average current I_sum in one frame period to IH and IL, where IH is the average current when a gentle ramp signal is used and IL is the average current when a steep ramp signal is used. The relation I_sum=IH+IL is satisfied. Creating a gamma LUT fixes IL at the maximum value in the high gray-level range and uses only IL in the low gray-level range. In the low gray-level range, IL is adjusted by the gray-level data voltage.

Referring to FIG. 19A and FIG. 19B, Creating the gamma LUT 327B to be used with a steep ramp signal increases the gray-level data voltage monotonically with increase in gray level when the average current is not more than the maximum value ILmax and fixes the gray-level data voltage when the average current is more than ILmax. Creating the gamma LUT 327A to be used with a gentle ramp signal fixes the gray-level data voltage when the average current is not more than the maximum value ILmax and monotonically increases the gray-level data voltage when the average current is more than ILmax.

### Embodiment 3

The foregoing embodiments describe simultaneous driving. The simultaneous driving writes gray-level data voltages pixel row by pixel row and lights all pixels after completion of writing to all pixel rows. The simultaneous driving does not write a gray-level data voltage to any pixel row during the emission period.

The driver circuit in this embodiment controls the display region by progressive driving. The progressive driving starts lighting pixels in each pixel row immediately after writing gray-level data voltages to the row without waiting for writing gray-level data voltages to the other rows. According to the estimated lengths of one frame period in the foregoing two driving methods, the progressive driving attains approximately 34% reduction, compared to the simultaneous driving; the progressive driving enables higher frame rate. In addition, the progressive driving reduces the display unevenness caused by IR drop because the number of simultaneously lighting micro-LEDs is smaller.

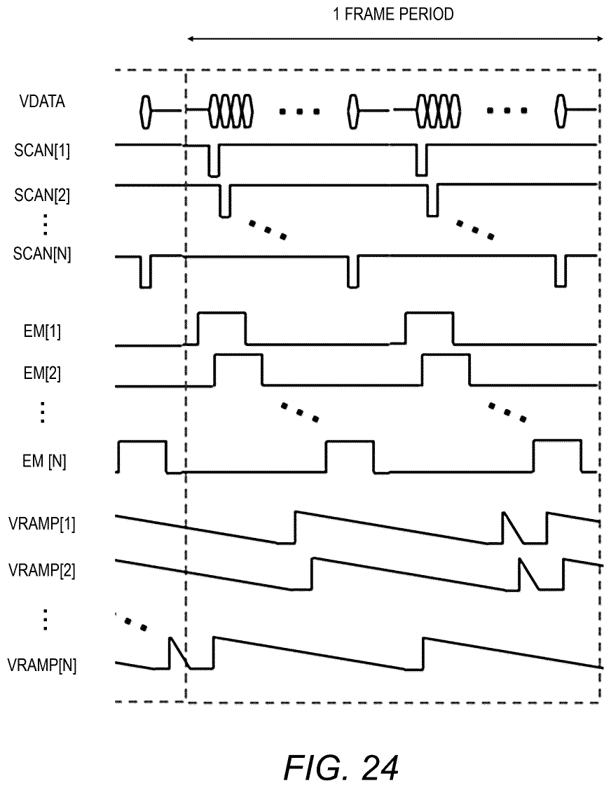

FIG. 24 is a timing chart of pixel control signals in the progressive driving. Differences from the timing chart in the simultaneous driving in FIG. 9 are mainly described. The reference sign EM[k] represents the emission control signal for the k-th pixel row. The reference sign VRAMP[k] represents the ramp signal for the k-th pixel row. Here, k is any natural number from 1 to N and N is a natural number larger than 2.

The time to control the gates of the driving transistors 121 in the (k+1)th pixel row is delayed from the time to control the gates of the driving transistors 121 in the k-th pixel row by one horizontal period. Like the scanning signal SCAN, the emission control signal EM and the ramp signal VRAMP are shifted by one horizontal period to be supplied to each pixel row.

The pixel circuits can have the same configuration as those for the simultaneous driving. Compared to the driver circuit for the simultaneous driving, the scanning circuits for the emission control signal EM and the ramp signal VRAMP are additionally included. In the driver circuit illustrated in FIG. 15, the signal circuit 31 outputs the ramp signal VRAMP; in the progressive driving, however, the added scanning circuit outputs the ramp signal VRAMP to the pixel rows one after another.

### Embodiment 4

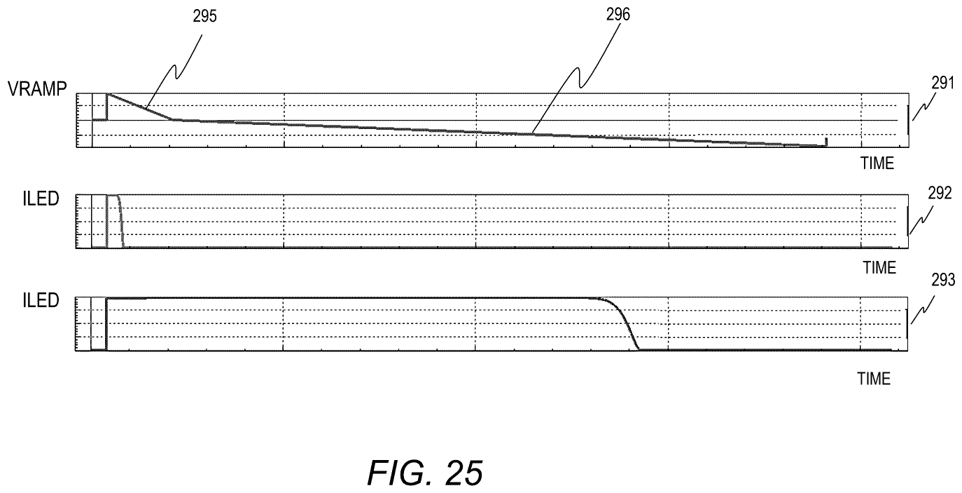

This embodiment changes the gradient of the ramp signal continuously. FIG. 25 provides temporal variation of the ramp signal in one frame period and simulation results on the temporal variation of the LED driving current for different gray levels.

The graph 291 provides a waveform of the ramp signal VRAMP in one frame period. The graph 292 provides a waveform of the LED driving current for a low gray level in one frame period. The graph 293 provides a waveform of the LED driving current for a high gray level in one frame period.

The waveform of the ramp signal in the graph 291 consists of continuous ramp signals having different gradients. In this example, the gradient of the ramp signal changes from a steep one to a gentle one. In other words, the ramp signal includes a steep ramp signal 295 and a following gentle ramp signal 296. The gradient of the ramp signal can avoid becoming too small at the maximum gray level by fixing the gradient of the gentle ramp signal 296.

Although the graph 291 in FIG. 25 provides a polygonal line using the ramp signal 295 and the ramp signal 296 as line segments, the gradient can be changed gradually to connect the two ramp signals smoothly. This configuration improves the brightness uniformity in displaying a gradation using the border between the ramp signals 295 and 296. Although the ramp signals 295 and 296 are expressed as line segments in FIG. 25, they can be connected non-linearly in such a manner that the gradient gradually decreases.

This embodiment supplies a pixel circuit with a ramp signal whose gradient is continuously changed to control the pulse width of the LED driving current with the gray-level data voltage. A steeper ramp signal can reduce the falling time of a short pulse. The underlying reason to do this is, when the pulse of the LED current is short, the emission duty is low to light a micro-LED 11 at a low gray level and when the pulse of the LED current is long, the emission duty is high to light a micro-LED 11 at a high gray level. Making the first part of the ramp signal or the ramp signal 295 steeper is to prioritize the improvement in display quality at low gray levels and making the second part or the ramp signal 296 gentler is to provide a sufficiently long width to the ramp signal, so that the upper limit of the emission duty or the peak brightness can be raised.

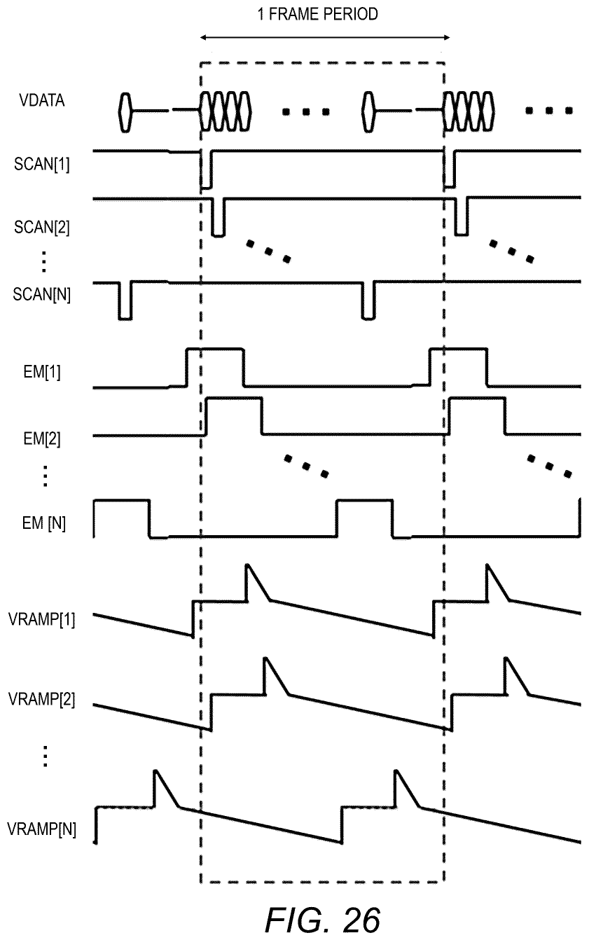

FIG. 26 is a timing chart of pixel control signals in this embodiment. Compared to the timing chart of FIG. 24, selecting a pixel row to write a gray-level data voltage by the scanning signal SCAN[k] is performed once per frame period. The waveform of the ramp signal VRAMP[k] has continuous different gradients. Here, k is any natural number from 1 to N and N is a natural number larger than 2. The first gradient is steep and the following gradient is gentle. Although FIG. 26 is an example for progressive driving, simultaneous driving is also applicable.

In this embodiment, the data write is once per frame and therefore, a high frame rate is available, compared to the other embodiments. In addition, the continuous ramp signals having different gradients can reduce the motion picture false contour of a kind of motion picture noise more than the other embodiments.

This is because this embodiment provides a single emission pulse per frame. Although the graph 291 includes a single polygonal ramp signal in one frame, multiple ramp signals can be included. The progressive driving requires ramp signals each delayed by one horizontal period; in the case of the single ramp signal per frame, ramp signals as many as the number N of scanning lines (VRAMP[1] to VRAMP[N]) are necessary as illustrated in FIG. 26. Defining the line segments of the ramp signal 295 and the ramp signal 296 as one set, let W to be the width of the one set and H to be one horizontal period. The number of ramp signals is W/H and it decreases as the width W is shorter. In application to the progressive driving, the number of ramp signals can be significantly reduced by reducing the width of the ramp signal and repeating the set.

### Embodiment 5

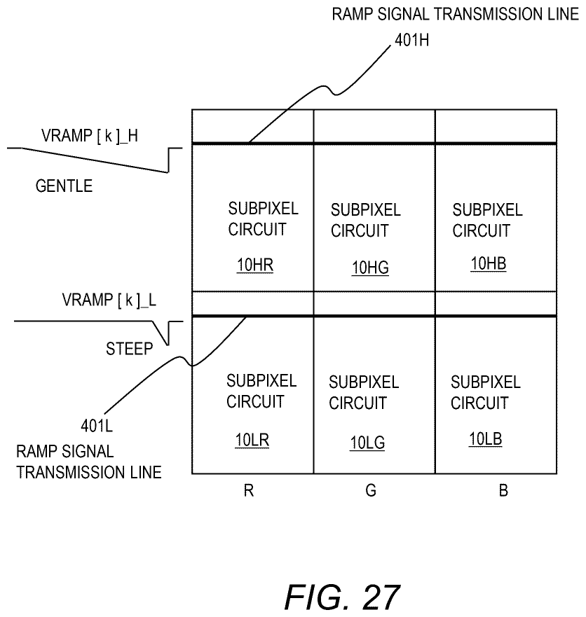

Embodiment 5 divides a pixel (a light-emitting region) into a plurality of subpixels to supply them with ramp signals having different gradients. FIG. 27 illustrates a configuration example where each pixel is divided into two subpixels. A pair of subpixel circuits 10HR and 10LR constitute an overall pixel circuit for one red pixel. A pair of subpixel circuits 10HG and 10LG constitute an overall pixel circuit for one green pixel. A pair of subpixel circuits 10HB and 10LB constitute an overall pixel circuit for one blue pixel. Each subpixel circuit is provided with a micro-LED connected thereto. Each micro-LED corresponds to a subpixel and one light-emitting region of a pixel consists of two micro-LEDs.

In the configuration example in FIG. 27, a subpixel circuit controls light emission of one micro-LED 11 associated therewith. The subpixel circuits 10HR, 10HG, and 10HB control the emission periods of the micro-LEDs 11 in accordance with a gentle ramp signal. The subpixel circuits 10LR, 10LG, and 10LB control the emission periods of the micro-LEDs 11 in accordance with a steep ramp signal.

Ramp signal transmission lines each dedicated to either kind of ramp signal are disposed in the display region. A ramp signal transmission line 401H for transmitting a gentle ramp signal VRAMP[k]_H extends through the region of a subpixel circuit row including subpixel circuits 10HR, 10HG, and 10HB. A ramp signal transmission line 401L for transmitting a steep ramp signal VRAMP[k]_L extends through the region of a subpixel circuit row including subpixel circuits 10LR, 10LG, and 10LB. Ramp signal transmission lines 401H extending through the subpixel circuit rows that use the gentle ramp signal and ramp signal transmission lines 401L extending through the subpixel circuit rows that use the steep ramp signal are disposed in the display region.

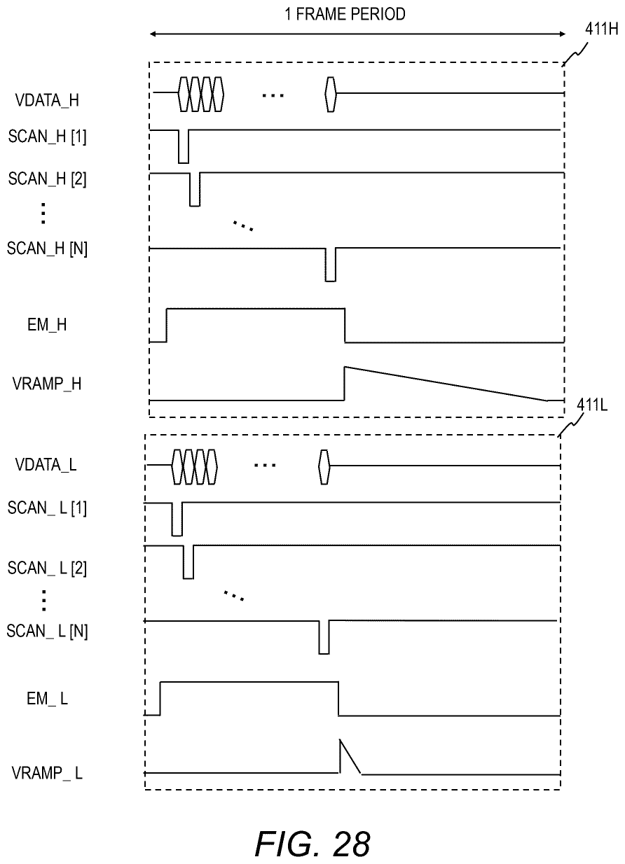

FIG. 28 is a timing chart of pixel control signals in this embodiment. The signal group 411H is a control signal group for the subpixel circuits that use the gentle ramp signal VRAMP_H. The signal group 411L is a control signal group for the subpixel circuits that use the steep ramp signal VRAMP_L.

The signal group 411H selects the subpixel rows that use the gentle ramp signal VRAMP_H one by one with the selection signal SCAN_H[k] and writes gray-level data voltages VDATA_H thereto. In the writing, it uses the common gamma LUT in FIG. 17.

The signal group 411L selects the subpixel rows that use the steep ramp signal VRAMP_L one by one with the selection signal SCAN_L[k] and writes gray-level data voltages VDATA_L thereto. The period to write a gray-level data voltage to a subpixel circuit is only once per frame. The signal group 411H and the signal group 411L write gray-level data voltages to all their subpixel circuit rows in the same period.

After the gray-level data voltages have been written to all subpixel circuit rows, all subpixel circuits start lighting the subpixels. The emission control signal EM_H controls emission of the micro-LEDs of the subpixel circuits that use the gentle ramp signal VRAMP_H. The emission control signal EM_L controls emission of the micro-LEDs of the subpixel circuits that use the steep ramp signal VRAMP_L. The waveforms of these emission control signals are identical.

In this embodiment, the period to write a gray-level data voltage to a subpixel circuit is once per frame period. In an emission period, ramp signals having different gradients are input simultaneously. Embodiments 1, 2, and 3 require time division to change the gradient of the ramp signal. This Embodiment 5 does not need this time division; the data write period can be reduced to once to attain a high frame rate as well as improved display quality.

As set forth above, embodiments of this disclosure have been described; however, this disclosure is not limited to the foregoing embodiments. Those skilled in the art can easily modify, add, or convert each element in the foregoing embodiments within the scope of this disclosure. A part of the configuration of one embodiment can be replaced with a configuration of another embodiment or a configuration of an embodiment can be incorporated into a configuration of another embodiment.

What is claimed is:

1. A display device comprising:
a plurality of pixel circuits; and
a control circuit configured to control the plurality of pixel circuits,
wherein each of the plurality of pixel circuit includes:
a control transistor for driving current for a pixel; and
a pulse width modulation circuit to supply a control signal to the control transistor,
wherein the pulse width modulation circuit includes a driving transistor to output the control signal,
wherein the pulse width modulation circuit is configured to switch ON/OFF the control transistor with the control signal to control an emission period of the pixel in one frame period,
wherein the pulse width modulation circuit is configured to switch ON/OFF the driving transistor using a gray-level data voltage from the control circuit, a first ramp signal, and a second ramp signal steeper than the first ramp signal,
wherein the second ramp signal is used in control for a low gray-level range including the minimum gray level and not used in control for a high gray-level range including gray levels higher than the low gray-level range, and
wherein the first ramp signal is used in at least the control for the high gray-level range.

2. The display device according to claim 1,
wherein the control circuit includes a first table and a second table each defining relations between gray levels and gray-level data voltages,
wherein the control circuit is configured to:
determine a gray-level data voltage in the high gray-level range with the first table; and
determine a gray-level data voltage in the low gray-level range with the second table, and
wherein each of the first table and the second table defines voltage varying monotonically or keeping a fixed value with increase in gray level.

3. The display device according to claim 2,
wherein, in the second table, the gray-level data voltage increases to a maximum value and then keeps the maximum value with increase in gray level, and
wherein, in the first table, the gray-level data voltage keeps a minimum value and then increases with increase in gray level.

4. The display device according to claim 1, wherein a time to control gates of the driving transistors in the (k+1)th pixel row is shifted from a time to control gates of the driving transistors in the k-th pixel row by one horizontal period.

5. The display device according to claim 1, wherein a slope of the second ramp signal and a slope of the first ramp signal are continuous and the slope of the second ramp signal precedes the slope of the first ramp signal.

6. The display device according to claim 1,
wherein the pixel includes a first light-emitting diode and a second light-emitting diode,
wherein the pixel circuit includes a first subpixel circuit to control the first light-emitting diode and a second subpixel circuit to control the second light-emitting diode,
wherein the first subpixel circuit is configured to use the first ramp signal, and
wherein the second subpixel circuit is configured to use the second ramp signal.

7. The display device according to claim 1, wherein the absolute value |a| of the gradient of the second ramp signal satisfies 1.44 V/ms<|a|<100 V/ms.

8. The display device according to claim 5, wherein the absolute value |a| of the gradient of the second ramp signal satisfies 1.44 V/ms<|a|<100 V/ms.
